(19) United States
(12) Patent Application Publication
(10) Pub. No.: US 2015/0165926 A1
(43) Pub. Date: Jun. 18, 2015

(54) HIGH VOLTAGE BATTERY SYSTEM FOR ELECTRIC VEHICLE

(71) Applicants: Hyundai Motor Company, Seoul (KR); Kia Motors Corporation, Seoul (KR)

(72) Inventors: Dal Kim, Suwon (KR); Jun Ho Bang, Anyang (KR); Min Wook Kim, Yongin (KR)

(21) Appl. No.: 14/530,126

(22) Filed: Oct. 31, 2014

(30) Foreign Application Priority Data
Dec. 12, 2013 (KR) 10-2013-0154618

(51) Int. Cl. B60L 11/18; H02J 7/00

(52) U.S. Cl. CPC B60L 11/1866; H02J 7/0026

(57) ABSTRACT

A high-voltage battery system is provided that ensures fail safety against a room-temperature short circuit and a high-temperature short circuit in a high-voltage battery in an electric vehicle. The battery system prevents secondary injury due to fire in a vehicle collision or in maintenance while ensuring fail safety against a room-temperature short circuit and a high-temperature short circuit by implementing a type of safety element that ensures fail safety by improving the structure of a cell tap, that is, by partially reducing the cross-sectional area of a current path such that a conductive portion is rapidly melted by substantially high heat when a short circuit occurs in a battery.

### CROSS-REFERENCE TO RELATED APPLICATION

This application claims under 35 U.S.C. §119(a) the benefit of Korean Patent Application No. 10-2013-0154618 filed Dec. 12, 2013, the entire contents of which are incorporated herein by reference.

### BACKGROUND

(a) Technical Field

The present invention relates to a high-voltage battery system for an electric vehicle, and more particularly, to a high voltage battery system that ensures fail safety for a room-temperature short circuit and a high-temperature short circuit of a high-voltage battery in an electric vehicle.

(b) Background Art

In general, electric vehicles use a battery engine operated by electric energy obtained from a battery. The electric vehicles use a battery formed in a pack with a plurality of chargeable/dischargeable secondary cells as the main power source, having the advantages of no exhaust gas and a reduced noise. The electric vehicles should have safety against various situations due to large capacities and high voltages.

For example, a device that automatically cuts the power during overcharging is provided and a device that opens a high-voltage relay, when a controller senses a dielectric breakdown is provided. However, when the most severe physical short circuit that would occur in various collisions and maintenance of vehicles occurs, and when the current flowing in this situation is not stopped rapidly, the cells increase in temperature and consequently ignite the battery system. When a short circuit occurs in a battery system assembly, the fuse of a safety plug is cut first and safety is ensured.

When a fuse is used even for a module and a pack, safety may be ensured, but the design cost thereof may increase. The current short tests of batteries may be classified into a room-temperature short circuit and a high-temperature short circuit. The room-temperature short circuit is tested to detect whether fail safety is ensured against a short circuit with a state of charge (SOC) of 100% and at surrounding temperature of about 25° C. and the high-temperature short circuit is tested to detect whether fail safety is ensured against a short circuit with SOC of 100% and at surrounding temperature of 60° C. The room-temperature short circuit may be severe or the high-temperature short circuit may be severe, depending on the characteristics of batteries. Safety may be ensured against a short circuit in cells of batteries, using the material for the level of the cells, but using a fuse for all of battery modules and packs to ensure their safety may cause problems such as increases in cost and output resistance.

FIG. 4 is an exemplary view showing a high-voltage battery system of the related art and FIG. 5 is an exemplary view showing a cell tap structure in the high-voltage battery system of the related art. In FIGS. 4 and 5, the high-voltage battery system includes a plurality of modules connected in series, for example, the first module M1 to the eighth module M8 and the cell taps 110 of the cells 100 in the modules are connected to a connecting terminal 130 by a laser-welded portion 120.

In addition, two cell taps 110 extending from the cells 100 and the connecting terminal 130 overlap in three layers and are connected by welding. In the high-voltage battery system, when a short circuit occurs in the unit of the entire battery system, a fuse 140 with an intended built-in safety plug may induce fail safety by cutting off the current. However, there is no battery in the units of the first module M1 to the fourth module M4 and the fifth module M5 to the eighth module M8, so a structure that can stop the path of a current is required in the modules to achieve the effect of a short circuit in the battery.

In the case 1 with a short circuit at the left side, the safety plug (e.g., for stopping a current path and for separating in maintenance) includes an internal built-in fuse, to ensure safety by cutting of the fuse against a short circuit. However, when a short circuit occurs on the path without a fuse, as in the case 2 and the case 3, ignition may be caused due to high current and increased heat while the current continues to flow thus not ensuring safety. In other words, the parts without a fuse on the current path are the sections of the first module M1 to the fourth module M4 and the fifth module M5 to the eighth module M8 that are connected in series (180V at each section). When a short circuit occurs, a current of about 12000 A generates ignition with increased heat and flame while the current flows through the current path between both ends at 180V, as shown in Table 1 below.

TABLE 1

| Location | Voltage | Safety element | Possibility of ignition |
|---|---|---|---|
| Case 1 | 360 V | Safety plug | No |
| Case 2 | 180 V | No | Yes |
| Case 3 | 52.5 V or 37.5 V | No | Yes |

One method for ensuring safety against short circuits is to mount a fuse in each of the modules. However, the cost necessarily to provide such a mount increases with an increase in the number of fuses and the output is decreased in traveling (e.g., discharging) and charging in the normal state (e.g., when no overcharging occurs) due to resistance of the fuses themselves, which causes reduction of efficiency in charging/discharging the battery.

The above information disclosed in this section is merely for enhancement of understanding of the background of the invention and therefore it may contain information that does not form the prior art that is already known in this country to a person of ordinary skill in the art.

### SUMMARY

The present invention provides a high-voltage battery system for an electric vehicle which may prevent secondary injury due to a fire in a vehicle collision or in maintenance while ensuring fail safety against a room-temperature short circuit and a high-temperature short circuit in the high-voltage battery by implementing a safety element that may ensure fail safety by improving the structure of a cell tap, that is, by partially reducing the conductive cross-sectional area to rapidly melt (e.g., evaporate) a conductive portion by heat when a short circuit occurs in a battery.

A high-voltage battery system for an electric vehicle provided by the present invention has the following characteristics to achieve the object. The high-voltage battery system for an electric vehicle may be composed of a power relay assembly, a battery management system, and a plurality of modules connected in series, and particularly, may include a structure in which cell taps of a plurality of cell sets in the modules and connecting terminals that connect the cell sets are connected by two welding portions and a melting portion between the welding portions. Accordingly, it may be possible to ensure fail safety against a high-temperature short circuit and a room-temperature short circuit by improving the structure of a cell tap without using a fuse.

The cell tap of each of the cell sets and the connecting terminal may be connected by a first welding portion that connects cell taps, a second welding portion that connects at least one cell tap extending to the connecting terminal and the connecting terminal, and a melting portion disposed between the first welding portion and the second welding portion. The cell tap portion that creates the melting portion between the welding portions may have a conductive cross-sectional area less than those of other cell tap portions. In addition, the two welding portions that connect the cell tap and the connecting terminal and the melting portion between the welding portions may be applied to the cell set in at least one of the modules including a plurality of cell sets.

The high-voltage battery system for an electric vehicle provided by the present invention has the following advantages. In a vehicle collision, a short circuit may occur by the steel parts coming in contact with a terminal, and when the short circuit occurs without a fuse in the current path (e.g., the case 1 or the case 2 in the related art), the short circuit may be maintained and ignition may be generated. However, when the technology of the present invention is applied, the conductive portion with the partially reduced cross-sectional area may be melted to stop the current and prevent a fire, and therefore, safety may be ensured. It may be possible to prevent a secondary injury of a passenger due to fire by a high-voltage short circuit in an accident such as a vehicle collision.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary view showing a high-voltage battery system according to an exemplary embodiment of the present invention;

FIG. 2 is an exemplary view showing a cell tap structure in the high-voltage battery system according to an exemplary embodiment of the present invention;

FIG. 3 is an exemplary diagram showing the results of tests on a module and a pack in the high-voltage battery system according to an exemplary embodiment of the present invention;

FIG. 4 is an exemplary view showing a high-voltage battery system of the related art; and

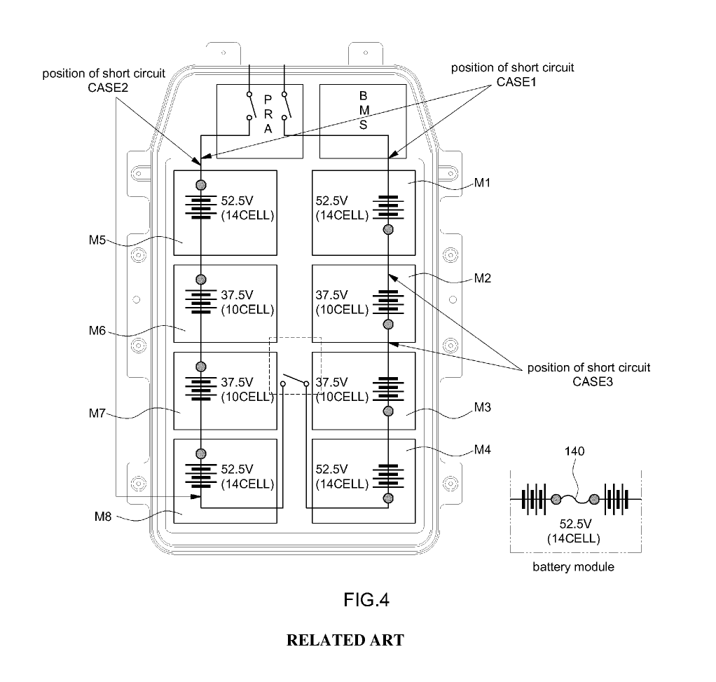

FIG. 5 is an exemplary view showing a cell tap structure in the high-voltage battery system of the related art.

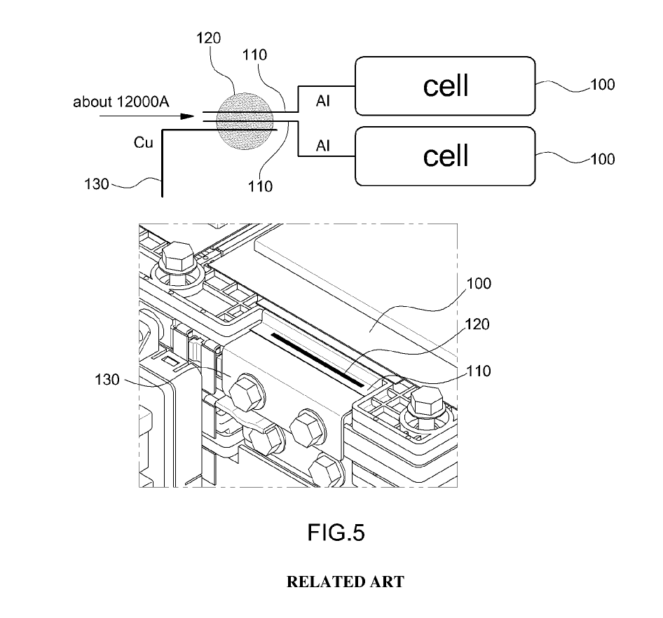

10: power relay assembly

11: battery management system

12, 12a-12h: module

13a, 13b: cell

14: connecting terminal

15a, 15b: cell tap

16: first welding portion

17: second welding portion

18: melting portion

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention is described in detail with reference to the accompanying drawings.

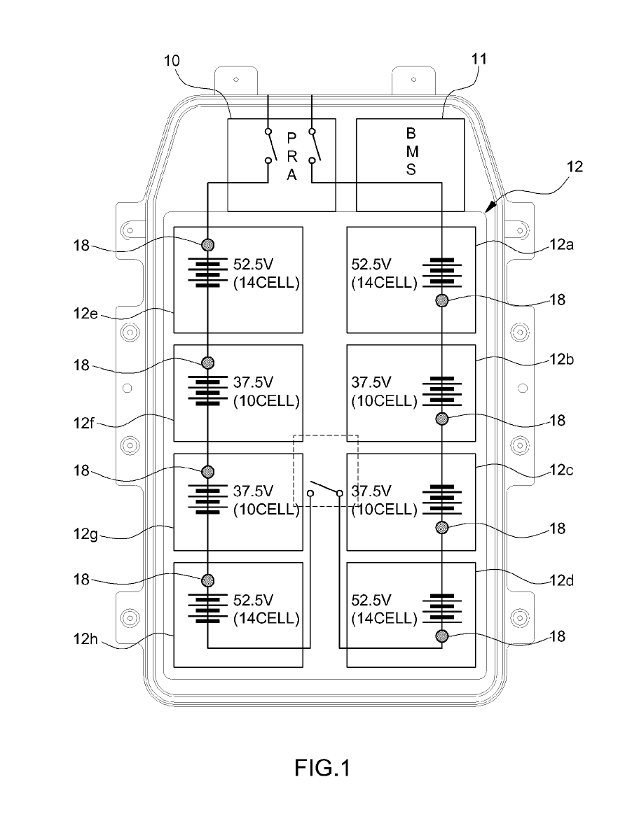

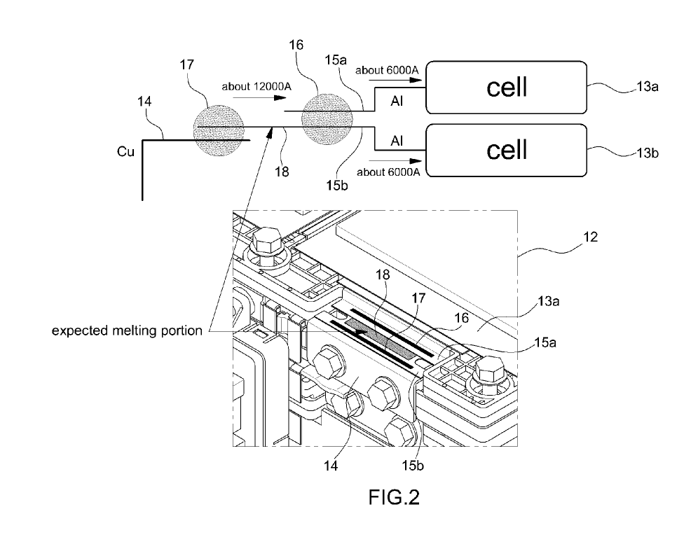

FIG. 1 is an exemplary view showing a high-voltage battery system according to an exemplary embodiment of the present invention and FIG. 2 is an exemplary view showing a cell tap structure in the high-voltage battery system according to an exemplary embodiment of the present invention. As shown in FIGS. 1 and 2, the high-voltage battery system may include a power relay assembly 10, a battery management system 11, and a plurality of modules 12 connected in series, for example, a first module 12a to a fourth module 12d connected in series and a fifth module 12e to an eighth module 12h connected in series.

The first module 12a to the eighth module 12h may be arranged in two lines each with four modules and electrically connected with the power relay assembly 10 etc. Further, the first module 12a to the eighth module 12h may each include a plurality of cell sets. For example, two cells 13a and 13b may form one set and may be connected with another adjacent cell set in series by a connecting terminal 14, such that a plurality of cell sets connected in series form one module 12.

Further, cell taps 15a and 15b for connection with the connecting terminal 14 may be formed at the cells of the cell sets, that is, two cells 13 and 13b, respectively, and the cell taps 15a and 15b and the connecting terminal 14 may be connected by at least two welding portions disposed at a predetermined distance from each other, that is, a first welding portion 16 and a second welding portion 17 and a melting portion 18 between the welding portions. Accordingly, the cell taps 15a and 15b may extend to a predetermined distance from the cell set in the module 12, that is, two cells 13a and 13b, and any one tap 15b of the cell taps 15a and 15b extending to the predetermined distance may be longer than the other cell tap 15a (e.g., the cell taps may extend at different lengths).

The cell taps 15a and 15b of the two cells 13a and 13b may be coupled by laser welding at the sides adjacent to the cells, to form the first welding portion 16, and the longer cell tap 15b may extend to the connecting terminal 14 and may be coupled to the connecting terminal 14 by laser welding to form the second welding portion 17. In other words, two cell taps and a connecting terminal may not be overlapped and may be welded in three layers, as in the related art, but a cell tap and a cell tap, and a cell tap and a connecting terminal may be overlapped and welded in two layers, respectively.

The portion of the cell tap 15b between the first welding portion 16 that connects the cell taps 15a and 15b and the second welding portion 17 that connects the cell tap 15b and the connecting terminal 14 may form the melting portion 18 to be rapidly melted by heat (e.g., temperature of a predetermined degree). In particular, the melting portion 18 formed by the portion of the cell tap 15b between the two welding portions, that is, the first welding portion 16 and the second welding portion 17 may have a conductive cross-sectional area less than those of the portions of other cell taps, that is, the portions of the cell taps connected by the first welding portion 16 and the portions of the cell taps connected by the second welding portion 17. In other words, the cell tap width of the melting portion 18 may be less than the cell tap widths of the first welding portion 16 and the second welding portion 17.

Accordingly, when a short circuit occurs, the three-layered welding portion of the related art ignites while the current continues to flow, even though a current of about 7000 A is flowing therethrough. However, resistance increases at the portion (e.g., melting portion) where the conductive cross-sectional area partially reduces, rapidly generating heat and the welding portion with the reduced conductive cross-sectional area may be melted (e.g., evaporated) by the rapidly formed heat. In other words, when a short circuit occurs and a current of about 12000 A flows to the cell taps 15a and 15b through the connecting terminal 14, heat may rapidly generate at the melting portion 18 and the melting portion 18 may be cut, to stop the current from flowing and prevent a potential fire.

Although the welding portions 16 and 17 and the melting portion 18 may be applied to all the cell sets in the modules 12a˜12h of the battery system, the welding portions and the melting portion may be applied to one of the cell sets in the modules 12a˜12h of the battery system in terms of the convenience in manufacturing and the cost. For example, the welding portions 16 and 17 and the melting portion 18 may be applied to each of the eight modules in the battery system. The welding portions 16 and 17 and the melting portion 18 in the modules may be applied to the cell sets at the inlets for charging/discharging of the modules, for example, the cell sets at the positions connected first with adjacent modules.

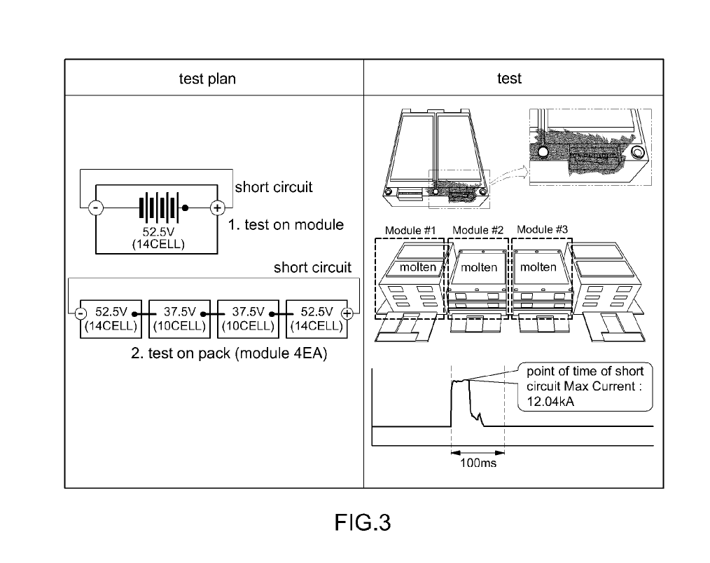

FIG. 3 is an exemplary diagram showing the results of tests on a module and a pack in the high-voltage battery system according to an exemplary embodiment of the present invention. FIG. 3 shows the results of short circuit tests on a module and a cell, using a cell tap (e.g., melting portions) with a reduced cross-sectional area. As a result of the tests, it was possible to ensure fail safety with melting of the cell tap having a reduced cross-sectional area, when a short circuit occurs. In both of the tests on a module and a cell and it was found that durability against vibration/shock in a vehicle was maitnained and no reduction of output was observed when charging/discharging a battery.

As described above, since a technology that may ensure fail safety against a short circuit by improving the structure of a cell tap such that the conductive cross-sectional area is partially reduced without a fuse, it may be possible to ensure safety, prevent ignition by cutting the melting portion to stop a current flow, even when a short circuit occurs in the situation such as a vehicle collision. In addition, it may be possible to prevent secondary injury due to fire that may occur due to a high-voltage short circuit.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A battery system for a vehicle, comprising:
a power relay assembly;
a battery management system configured to control the charging and discharging of the battery system; and
a plurality of modules connected in series and electrically connected to the power relay assembly,
wherein cell taps of a plurality of cell sets within the modules and connecting terminals that connect the cell sets are connected by two welding portions and a melting portion between the welding portions.

2. The battery system for an electric vehicle of claim 1, wherein the cell tap of each of the cell sets and the connecting terminal are connected by a first welding portion that connects the cell taps, a second welding portion that connects at least one cell tap extending to the connecting terminal and the connecting terminal, and a melting portion between the first welding portion and the second welding portion.

3. The battery system for an electric vehicle of claim 2, wherein the cell tap portion that forms the melting portion between the two welding portions has a conductive cross-sectional area less than a conductive cross-sectional area of other cell tap portions.

4. The battery system for an electric vehicle of claim 2, wherein the two welding portions that connect the cell tap and the connecting terminal and the melting portion between the welding portions are applied to the cell set in at least one of the modules including a plurality of cell sets.
